(19) United States
(12) Patent Application Publication
(10) Pub. No.: US 2015/0062635 A1
(43) Pub. Date: Mar. 5, 2015

(54) SHEET MANAGEMENT APPARATUS, METHOD OF CONTROLLING SHEET MANAGEMENT APPARATUS, AND STORAGE MEDIUM

(71) Applicant: CANON KABUSHIKI KAISHA, Tokyo (JP)

(72) Inventor: Makoto Anno, Tokyo (JP)

(21) Appl. No.: 14/470,690

(22) Filed: Aug. 27, 2014

(30) Foreign Application Priority Data
Sep. 2, 2013 (JP) 2013-181187

(51) Int. Cl. G06K 15/00

(52) U.S. Cl. CPC G06K 15/4065
USPC 358/1.15

(57) ABSTRACT

A sheet management apparatus includes a storing unit, an obtaining unit, and a setting unit. The storing unit stores a combination of a size and first property information of a first sheet and a size and second property information of a second sheet. The obtaining unit obtains a first size of a sheet held in a first sheet holding unit and a second size of a sheet held in a second sheet holding unit. The setting unit sets sheet property information such that the first property information is read out from the combination and the read first property information is set as sheet property information of a sheet held in the first sheet holding unit, and the second property information is read out from the combination and the read second property information is set as sheet property information of a sheet held in the second sheet holding unit.

### BACKGROUND OF THE INVENTION

1. Field of the Invention

The present invention relates to a sheet management apparatus capable of effectively using property information of a sheet held in a sheet holding unit, a method of controlling such a sheet management apparatus, and a storage medium.

2. Description of the Related Art

In related techniques, in a case where printing is performed using a printing apparatus having a sheet holding unit, it is commonly performed to set in advance sheet property information so as to be related to the sheet holding unit in terms of, for example, a name of a sheet, a size of the sheet, a basis weight of the sheet, a surface property of the sheet, a color of the sheet, and/or the like. To save sheet property information so as to be related to the sheet holding unit, it is necessary to input sheet property information individually for each sheet holding unit each time the setting is performed, which may need a troublesome operation. To handle the above situation, it is known to register in advance property information of each sheet in a sheet management database such that a user is allowed to select desired property information of a sheet from the sheet management database and save the selected sheet property information so as to be related to a particular sheet holding unit (Japanese Patent Laid-Open No. 2007-241425).

In the technique disclosed in Japanese Patent Laid-Open No. 2007-241425, in a case where a large number of sheets are registered in the sheet management database, a user may have to perform a troublesome operation to find a particular sheet from the large number of sheets registered each time printing is performed. In a case where a plurality of sheet holding units are used in executing a job, it is necessary to save property information such that property information of a plurality of sheets is correctly related to a corresponding one of the plurality of sheet holding units. In such a situation, to save sheet property information individually for each sheet holding unit, a user may have to perform a complicated and troublesome operation.

### SUMMARY OF THE INVENTION

According to an aspect of the present invention, a sheet management apparatus includes a storing unit configured to store a combination of a size and first property information of a first sheet and a size and second property information of a second sheet, an obtaining unit configured to obtain a first size of a sheet held in a first sheet holding unit and a second size of a sheet held in a second sheet holding unit, and a setting unit configured to set sheet property information such that the first property information is read out from the combination including the first size and the second size obtained by the obtaining unit and the read first property information is set as sheet property information of a sheet held in the first sheet holding unit, and the second property information is read out from the combination and the read second property information is set as sheet property information of a sheet held in the second sheet holding unit.

Further features of the present invention will become apparent from the following description of exemplary embodiments with reference to the attached drawings.

### BRIEF DESCRIPTION OF THE DRAWINGS

FIG. 1 is a diagram illustrating a printing system according to a first embodiment.

FIG. 2 is a block diagram illustrating a configuration of a server according to the first embodiment.

FIG. 3 is a block diagram illustrating a configuration of a printing apparatus according to the first embodiment.

FIG. 4 is a diagram illustrating data stored in a hard disk drive (HDD) unit of a server according to the first embodiment.

FIG. 5 is a flow chart illustrating a process performed by a server to register sheet information in a sheet information storage unit according to the first embodiment.

FIG. 6 is a flow chart illustrating a process performed by a server to register a group in a group setting storage unit according to the first embodiment.

FIG. 7 is a diagram illustrating an example of a sheet information registration screen for registering sheet information in a sheet information storage unit according to the first embodiment.

FIG. 8 is a diagram illustrating an example of a group registration screen for registering group setting in a group setting storage unit according to the first embodiment.

FIG. 9 is a diagram illustrating an example of a warning screen displayed on an operation unit of a printing apparatus according to the first embodiment.

FIG. 10 is a diagram illustrating an example of a list of groups registered in a group setting storage unit of a server according to the first embodiment.

FIG. 11 is a flow chart illustrating a process performed by a printing apparatus to register sheet property information for a group all at once such that the property information of each sheet is related to a corresponding one of sheet feeding units in the group according to the first embodiment.

FIG. 12 is a flow chart illustrating a process performed by a server to search for a group registered in a group setting storage unit according to the first embodiment.

FIG. 13 is a diagram illustrating an example of a confirmation screen displayed on an operation unit of a printing apparatus according to the first embodiment.

FIGS. 14A and 14B are diagrams illustrating examples of sheet property information registered individually for each sheet feeding unit of a printing apparatus according to the first embodiment.

FIGS. 15A and 15B are diagrams illustrating examples of values of flags associated with respective sheet feeding units in each group registered in a group setting storage unit in a server according to the first embodiment.

FIG. 16 is a flow chart illustrating a process performed by a printing apparatus to register sheet property information for a group all at once such that the property information of each sheet is related to a corresponding one of sheet feeding units in the group according to a second embodiment.

FIG. 17 is a flow chart illustrating a process performed by a server to search for a group registered in a group setting storage unit according to the second embodiment.

FIG. 18 is a diagram illustrating an example of a selection screen displayed on an operation unit of a printing apparatus according to the second embodiment.

FIG. 19 is a diagram illustrating an example of a confirmation screen displayed on an operation unit of a printing apparatus according to the second embodiment.

### DESCRIPTION OF THE EMBODIMENTS

Embodiments of the invention are described in detail below with reference to accompanying drawings. Note that the purpose of the embodiments described below is not to limit the invention. Also note that all parts, elements, or steps described in the embodiments are not necessarily needed to practice the invention.

### First Embodiment

### Printing system

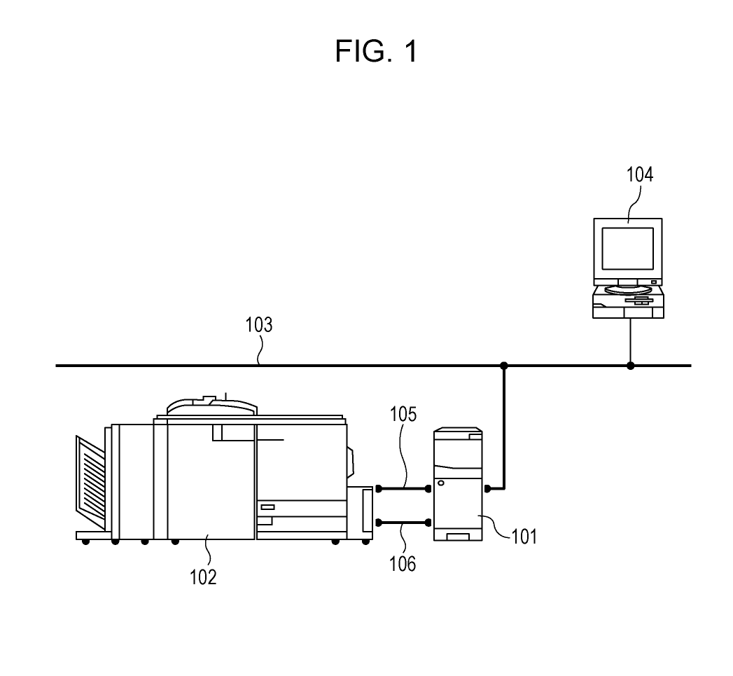

Referring to FIG. 1, a printing system according to a first embodiment of the invention is described below.

A printing apparatus (printer) 102 has various functions including scanning, printing, copying, and/or the like. A server 101 has various functions including image processing, print controlling, job managing, and/or the like. An information processing apparatus (computer or the like) 104 has functions including editing an application file, instructing printing, and/or the like.

In this printing system, the printing apparatus 102 and the server 101 are connected to each other via a network 105, and a video cable 106. Furthermore, the server 101 and the information processing apparatus 104 are connected to each other via a network 103 such as a LAN, a WAN, or the like or a wireless LAN such that they are allowed to communicate with each other. The video cable 106 is used to transfer a print image, and the network 105 is used to transmit/receive other kinds of information. In the following description, the network used to connect the printing apparatus 102 and the server 101 may be a LAN, a WAN, or the like unless otherwise specified and as long as functions of the invention are realized.

Note that embodiments are described below by way of example for a case where the information processing apparatus 104 does not transmit or receive data or commands directly to or from the printing apparatus 102. Instead, in the present embodiment, the information processing apparatus 104 transmits and receives various kinds of data to or from the printing apparatus 102 via the server 101. The server 101 transfers a print job received from the information processing apparatus 104 connected to the server 101 to the printing apparatus 102. A user is allowed to check a status of a job or a status of the server 101 or the printing apparatus 102 by using the information processing apparatus 104. A user is allowed to directly or remotely operate the server 101 to save sheet property information, for example, in the printing apparatus 102 such that the sheet property information is related to a sheet feeding unit (a sheet holding unit) of the printing apparatus 102.

In a case where the information processing apparatus 104 also plays a role as a server instead of the server 101, the information processing apparatus 104 may transmit/receive data or a command directly to/from the printing apparatus 102. In this case, the information processing apparatus 104 may be configured in a similar manner to the server 101 except that the information processing apparatus 104 is connected to the printing apparatus 102 via the network 105 and the video cable 106.

### Configuration of Server

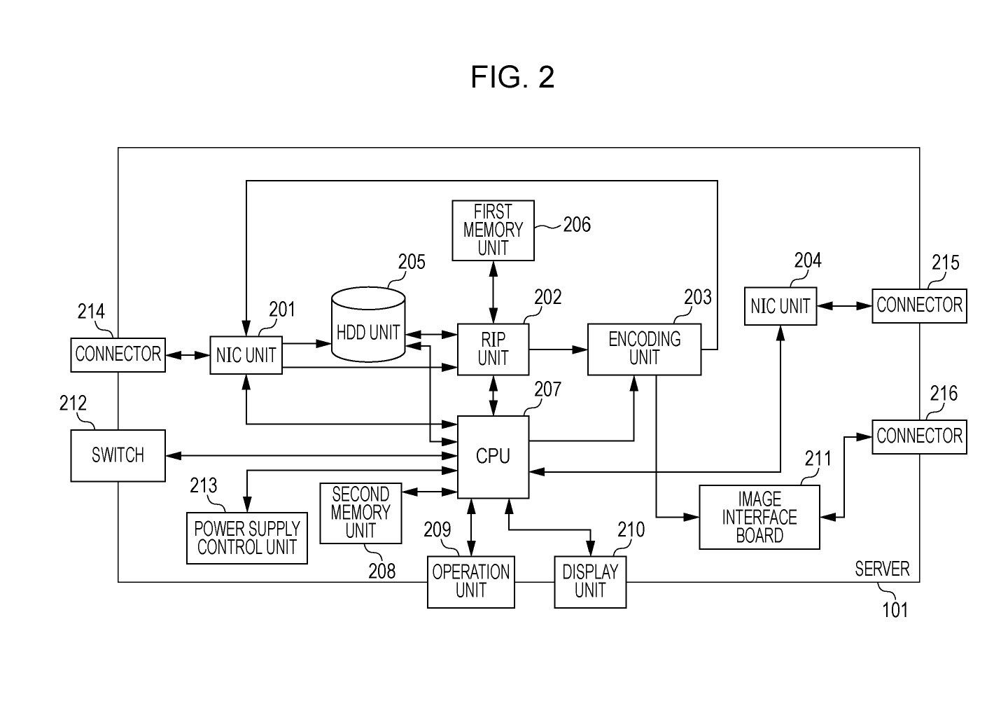

An example of a configuration of the server 101 according to the first embodiment of the invention is described below with reference to FIG. 2.

A network interface card (NIC) 201 functions as a first network interface providing an interface between the network 103 and lower layer levels. On the other hand, a NIC 204 functions as a second network interface providing an interface with lower layer levels.

A raster image processor (RIP) unit 202 performs a process to convert data received via the NIC unit 201 from a format represented in a printing language such as a page description language (PDL) or a particular data format into a raster image.

An encoding unit 203 performs a process to convert raster image data into print data in a format supported by the printing apparatus 102 or in other data formats.

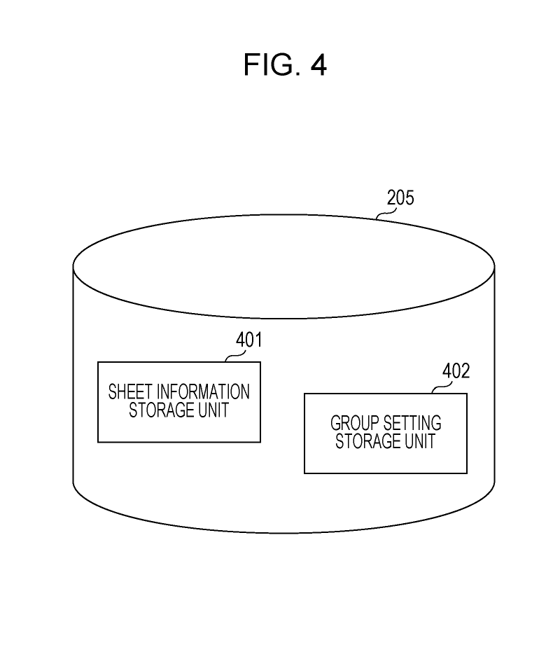

A hard disk drive (HDD) unit 205 temporarily stores (spools) print data received via the NIC unit 201 or temporarily stores compressed data after being subjected to the RIP process. In the HDD unit 205, a sheet information storage unit 401 and a group setting storage unit 402 are allocated and data is stored therein as described later with reference to FIG. 4. In addition to data stored in the sheet information storage unit 401 and the group setting storage unit 402, system software used in various processes described below are also stored in the HDD unit 205. The data stored in the sheet information storage unit 401 and the data stored in the group setting storage unit 402 may be stored in a nonvolatile memory such as a solid state drive (SSD) instead of the HDD unit 205.

A central processing unit (CPU) 207 controls processes or operations performed by various units in the server 101. A first memory unit 206 is used in an image format conversion process performed by the RIP processing unit 202. On the other hand, a second memory unit 208 is used by the CPU 207 as a temporary data storage area.

An operation unit 209 includes a button, a key, a touch panel, and/or the like, and is used to operate the server 101. A display unit 210 performs a process to provide information to a user using an image or a character. An image interface board 211 and a connector 216 for the image interface board 211 are used in producing image data and transferring the resultant image data to a dedicated transmission line. A switch 212 is operated by a user to turn on/off electric power. When the switch 212 is operated, an interrupt to the CPU 207 occurs. Upon detecting the interrupt, the CPU 207 controls a power supply control unit 213 depending on a state.

A data packet from the information processing apparatus 104 to the server 101 is transmitted via the network 103 and is received by the server 101 via a connector 214. In the server 101, the NIC unit 201 performs reception processing on data. In a case where print data is received, under the control of the CPU 207, the received data is stored into the HDD unit 205 as necessary. The storing of data into the HDD unit 205 is generally performed to enhance a data transfer speed. This technique is generally known as cueing (spooling). The data stored in the HDD unit 205 is read out by the RIP processing unit 202 under the control of the CPU 207.

Subsequently, based on preset data formats interpretable by the printing apparatus 102 and the data format of the received data, the encoding unit 203 functioning as the data format conversion unit encodes the data into a data format interpretable by the printing apparatus 102. It is required that the encoded data has a data format interpretable by the printing apparatus 102.

The data format may vary depending on an ability of an interpretation unit possessed by the printing apparatus 102. An example of a data format is a particular printing language format or a compressed data format such as JBIG or the like. The resultant data encoded in the above-described manner is again converted by the NIC unit 204 into a data packet for transmission to the network 105 and is transmitted from the connector 215 to the printing apparatus 102 via the network 105. Alternatively, the encoded data may be transmitted to the printing apparatus 102 via a local interface such as a universal serial bus (USB).

Upon receiving the data packet, the printing apparatus 102 performs printing on a recording medium such as a sheet according to a printing procedure defined in the printing apparatus 102.

Another method of transferring data is to transfer the data to the image interface board 211 via the encoding unit 203 and further transmit the data from the connector 216 to the printing apparatus 102 via the video cable 106. In the transmission of data packets, the information processing apparatus 104 acquires, as necessary, information indicating a power status of the server 101 and the printing apparatus 102 and/or information indicating whether they are in a normal state, and, depending on the acquired information, the information processing apparatus 104 transmits data packet to the server 101. The information processing apparatus 104 performs polling at regular time intervals to detect the power supply state and the operation state of the server 101 and the printing apparatus 102 thereby acquiring a state change notification packet transmitted from the server 101 or the printing apparatus 102. For example, in a case where the information processing apparatus 104 receives a power supply state notification packet indicating turning-off of the power of the printing apparatus 102, the information processing apparatus 104 stops the polling, which makes it possible to prevent unnecessary traffic from occurring on the network.

### Configuration of Printing Apparatus

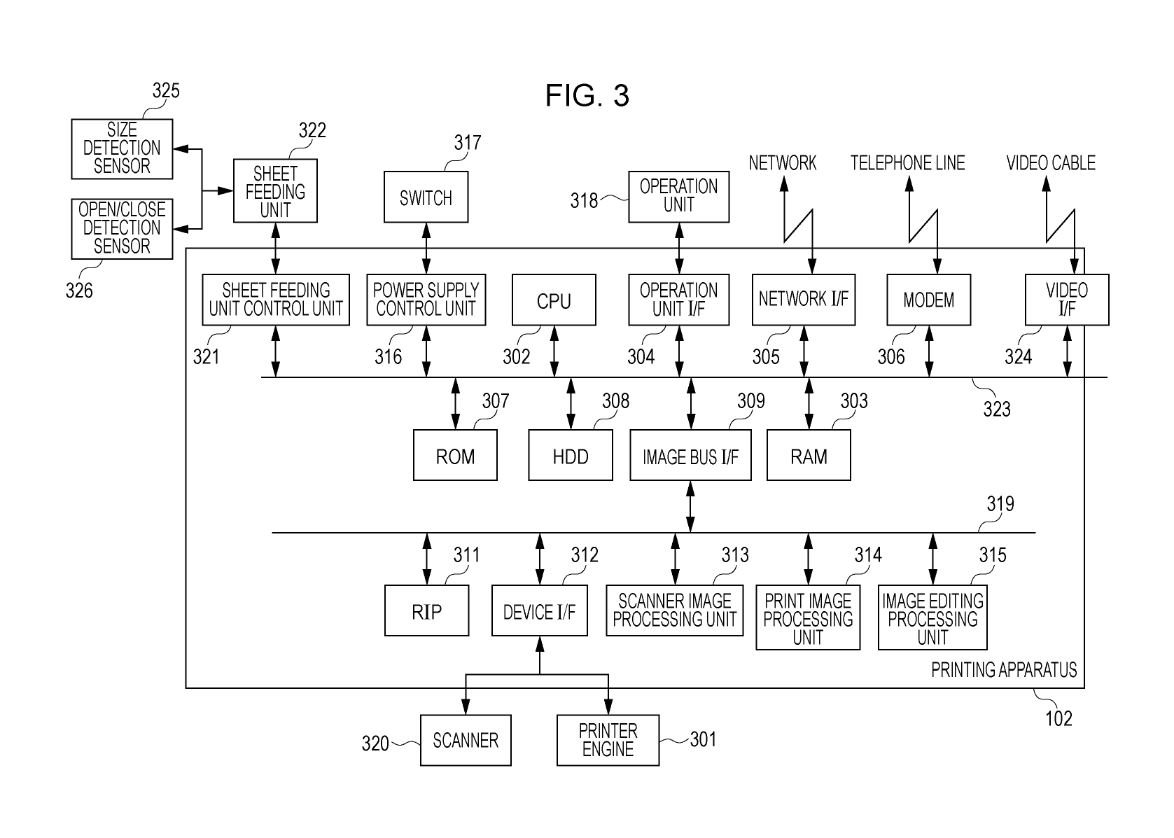

Referring to FIG. 3, an example of a configuration of the printing apparatus 102 according to the first embodiment of the invention is described below.

The printing apparatus 102 includes a plurality of sheet feeding units (sheet holding units) 322. The sheet feeding units may be sheet feed trays or manual sheet feed trays or a combination of sheet feed trays and manual sheet feed trays. Each sheet feeding unit (sheet holding unit) 322 includes a size detection sensor 325 configured to detect the size of a sheet held in the sheet feeding unit (sheet holding unit), an open/close detection sensor 326 configured to detect an operation of opening/closing the sheet feeding unit, and the like. Each sheet feeding unit (sheet holding unit) 322 may further include a sensor for detecting the remaining number of sheets on the sheet feeding unit (sheet holding unit) 322, a sensor for detecting a color or a surface property of a sheet held on the sheet feeding unit (sheet holding unit) 322, and/or the like.

The printing apparatus 102 is connected to a scanner 320 functioning as an image input device and a printer engine 301 functioning as an image output device thereby controlling reading or printing of image data. The printing apparatus 102 may be connected to a network, a telephone line, a video cable, or the like to make it possible to input/output image information or device information via the network or the video cable.

The CPU 302 is a central processing unit that controls the whole printing apparatus 102. A RAM 303 is a system work memory used in an operation by the CPU 302. The RAM 303 is also used as an image memory for temporarily storing input image data. A ROM 307 is a boot ROM in which a system boot program is stored. The HDD 308 is a hard disk drive for storing system software used in various kinds of processing described below. The HDD 308 is also used to store input image data and the like.

An operation unit I/F 304 is a unit providing an interface with an operation unit 318 including a display screen capable of displaying image data or the like, and the operation unit I/F 304 is configured to output operation screen data to the operation unit 318. The operation unit I/F 304 also serves to transfer information input by a user via the operation unit 318 to the CPU 302. The operation unit 318 includes a touch panel unit and a key input unit, which are not illustrated in the figure. The operation unit 318 provides various kinds of interfaces in performing setting or operations, by a user, on the printing apparatus 102 according to the first embodiment.

A network I/F 305 realized, for example, by a LAN card or the like is connected to a network to input/output information from/to an external apparatus. A modem 306 is connected to a telephone line to input/output information from/to an external apparatus. A video I/F 324 is connected to a video cable to input/output information from/to an external apparatus.

Note that the units described above are disposed on a system bus 323.

An image bus I/F 309 is an interface for connecting the system bus 323 to an image bus 319 for transferring image data at a high speed, and the image bus I/F 309 provides a function of a bus bridge to convert a data structure. A raster image processor (RIP) 311, a device I/F 312, a scanner image processing unit 313, a printer image processing unit 314, and an image editing processing unit 315 are disposed on the image bus 319.

The RIP 311 is a raster image processor that converts data expressed in a page description language (PDL) into a raster image. The device I/F 312 performs a synchronous/asynchronous conversion on image data sent/received to/from the scanner 320 or the printer engine 301. The scanner image processing unit 313 performs various processes such as a correction process on image data input from the scanner 320. The printer image processing unit 314 performs processes such as a correction process and a resolution conversion process depending on the printer engine and/or the like on image data to be printed. The image editing processing unit 315 performs various kinds of image processing such as rotation, compression/expansion, and/or the like, on image data.

A switch 317 is operated by a user to turn on/off electric power. When the switch 317 is operated, a power supply control unit 316 issues an interrupt to the CPU 302. Upon detecting the interrupt, the CPU 302 controls the power supply control unit 316 depending on a state.

A sheet feeding unit control unit 321 is a module configured to store sheet property information so as to be related to the sheet feeding unit 322 and control a sheet feeding operation. Furthermore, the sheet feeding unit control unit 321 stores setting information given from the operation unit 318, setting information received from the server 101, and sheet property information detected for the sheet feeding unit 322. The printing apparatus 102 controls printing based on the stored sheet property information related to the sheet feeding unit. The sheet property information may include, for example, information indicating a size, a basis weight, a color, a sheet type, and/or the like, of a sheet.

For example, based on a size of a sheet used in a print job to be performed, the printing apparatus 102 determines a sheet feeding unit 322 from which to feed the sheet, and controls the operation such that the sheet is fed from the determined sheet feeding unit 322. Furthermore, the printing apparatus 102 controls a sheet conveying speed and temperature of a fixing unit based on the basis weight and the sheet type of the sheet. The sheet feeding unit control unit 321 acquires information associated with the open/close operation of the sheet feeding unit 322 from the open/close detection sensor 326 to detect whether the sheet feeding unit 322 is closed from an open state.

In the present embodiment, the sheet information storage unit 401, the group setting storage unit 402, and the status information storage unit 403 are realized in storage areas allocated in the HDD unit 205 of the server 101 as illustrated in FIG. 4. Alternatively, the sheet information storage unit 401 and the group setting storage unit 402 may be realized in storage areas in the HDD 308 of the printing apparatus 102. Still alternatively, the sheet information storage unit 401 and the group setting storage unit 402 may be realized in storage areas of a not-illustrated nonvolatile memory in the information processing apparatus 104. In this case, data stored in the sheet information storage unit 401 and the group setting storage unit 402 may be accessed via the network 103.

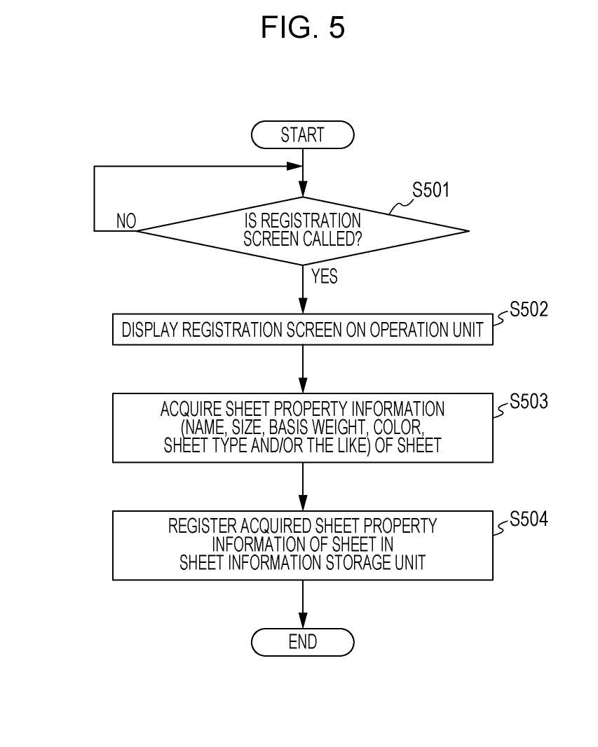

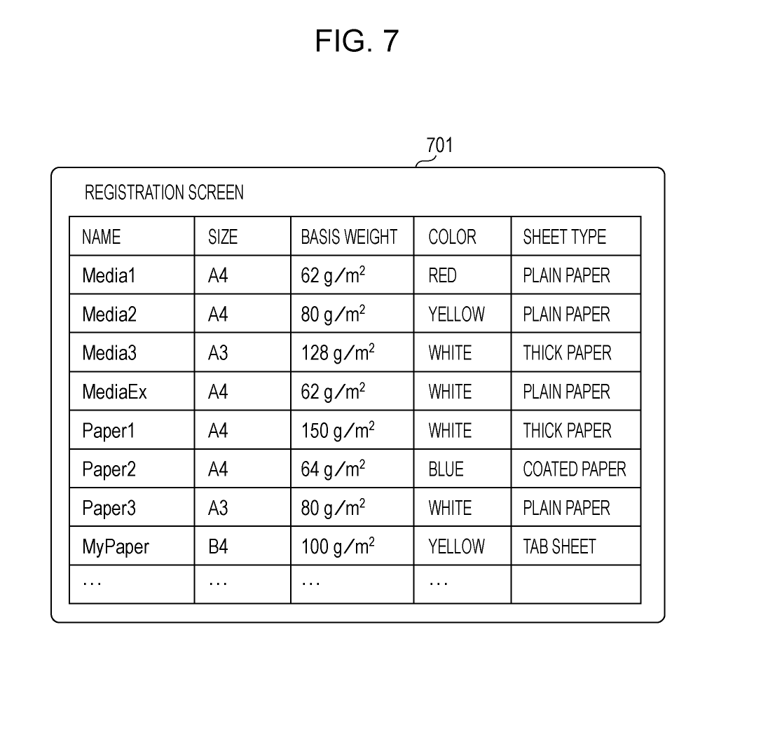

The sheet information storage unit 401 stores property information in the form of a list for all sheets registered by a user (FIG. 7). The sheet property information registered in the sheet information storage unit 401 includes, for example, a name, a size, a basis weight, a color, and a sheet type of the sheet. A process of registering sheet information in the sheet information storage unit 401 will be described later with reference to FIG. 5.

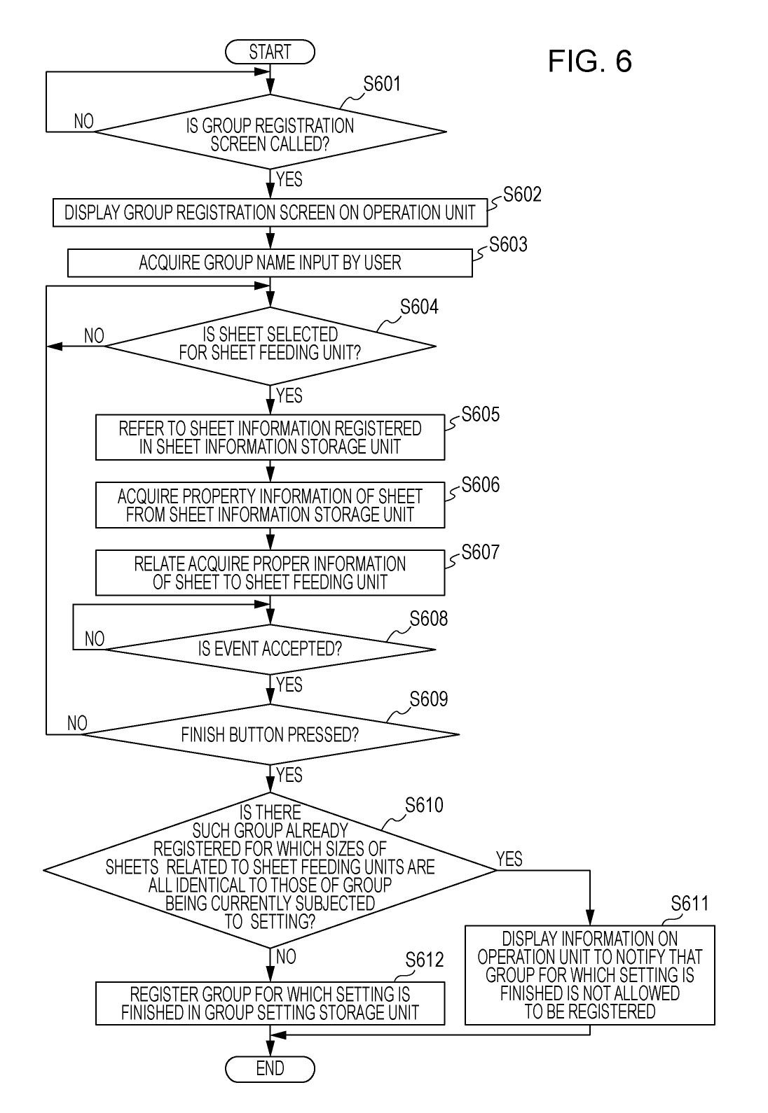

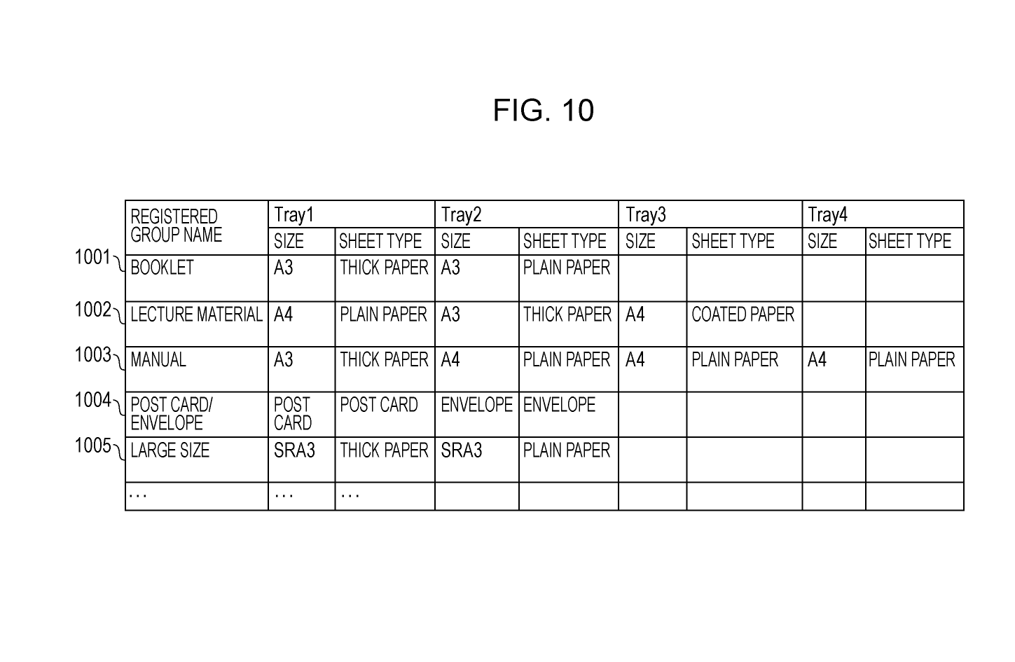

The group setting storage unit 402 stores property information in the form of a list such that property information of a sheet is related to one of sheet feeding units belonging to a group (FIG. 10). For example, in a case where book binding printing is performed such that color printing is performed on A3 coated paper for cover paper and black-and-white printing is performed on A3 plain paper for main-part paper, a group for book binding printing may be registered for example such that A3 coated paper may be related to a sheet feeding unit Tray1 and A3 plain paper may be related to a sheet feeding unit Tray2. Note that property information of a sheet to be related to a particular sheet feeding unit may be given such that when a user selects a sheet from sheets registered in the sheet information storage unit 401, the property information of the selected sheet is read from the sheet information storage unit 401. A process of registering a group in the group setting storage unit 402 will be described later with reference to FIG. 6.

A process of registering sheet information in the sheet information storage unit 401 is described below with reference to a flow chart illustrated in FIG. 5. This process is performed on the server 101 such that the CPU 207 executes a program loaded from the HDD unit 205 into the second memory unit 208. Although in the present embodiment, the process of registering sheet information in the sheet information storage unit 401 is described for a case where the process is performed on the server 101, the process may alternatively be performed on the printing apparatus 102. In the case where the process is performed on the printing apparatus 102, the CPU 302 may execute a program loaded from the HDD 308 into the RAM 303 to achieve the process. On the other hand, in a case where the information processing apparatus 104 plays a role as a server instead of the server 101, the process described above may be performed on the information processing apparatus 104.

First, in S501, the CPU 207 determines whether a registration screen 701 such as that illustrated in FIG. 7 is called. Note that the registration screen 701 is displayed on the operation unit 209 of the server 101. As for the sheet property information, for example, a name, a size, a basis weight, and a sheet type may be registered for a particular sheet in the form of a list.

In a case where it is determined in S501 that the registration screen 701 is called, the processing flow proceeds to S502. On the other hand, in a case where it is determined that the registration screen 701 is not called, the processing flow remains in S501.

In S502, the CPU 207 displays the registration screen 701 on the operation unit 209 of the server 101. The processing flow then proceeds to S503.

In S503, the CPU 207 acquires property information representing a name, a size, a basis weight, a color, and a sheet type of a sheet input by a user via a sheet information input screen (not illustrated) on the operation unit 209 of the server 101. The processing flow then proceeds to S504. Note that sheet information about the name, the size, the basis weight, the color, and the sheet type may alternatively be imported from an external apparatus such as the information processing apparatus 104, the printing apparatus 102, or the like.

In S504, in response to pressing of a register button on a non-illustrated sheet information input screen on the operation unit 209 of the server 101, the CPU 207 registers the sheet property information acquired in S503 in the sheet information storage unit 401 allocated in the HDD unit 205 of the server 101.

The details of the sequence of steps of the process of registering sheet information in the sheet information storage unit 401 have been described above. In the case where the process is performed on the printing apparatus 102, the process may be performed in a similar manner to a case where the process is per formed on the server 101 if the units used in the process are read as follows. That is, the CPU 207, the operation unit 209, and the HDD unit 205 used in the process on the server 101 respectively may be read as the CPU 302, the operation unit 318, and the HDD 308 in the process on the printing apparatus 102.

Next, a process of registering a group in the group setting storage unit 402 is described below with reference to a flow chart illustrated in FIG. 6. This process is performed on the server 101 such that the CPU 207 executes a program loaded from the HDD unit 205 into the second memory unit 208. Although in the present embodiment, the process of registering the group in the group setting storage unit 402 is described for a case where the process is performed on the server 101, the process may alternatively be performed on the printing apparatus 102. In the case where the process is performed on the printing apparatus 102, the CPU 302 may execute a program loaded from the HDD 308 into the RAM 303 to achieve the process. On the other hand, in a case where the information processing apparatus 104 plays a role as a server instead of the server 101, the process described above may be performed on the information processing apparatus 104.

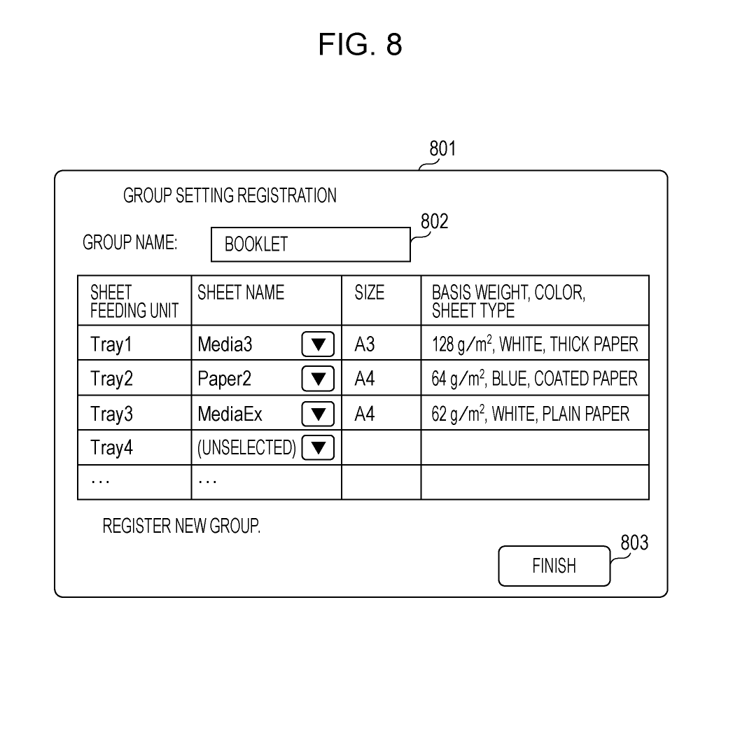

First, in S601, the CPU 207 determines whether a group registration screen 801 such as that illustrated in FIG. 8 is called. Note that the registration screen 801 is displayed on the operation unit 209 of the server 101. On the registration screen 801, it is allowed to select a sheet for a sheet feeding unit from sheets registered in the sheet information storage unit 401 by selecting one of sheets displayed in a drop-down box. Upon selecting the sheet, the property information (the size, the basis weight, the color, and the sheet type) of the selected sheet is related to the sheet feeding unit.

In the example illustrated in FIG. 8, a sheet “Media3” registered in the sheet information storage unit 401 is selected for a sheet feeding unit Tray1, and thus property information “size: A3, basis weight: 128 g/m², color: White, sheet type: thick paper” of the Media3 is related to the sheet feeding unit Tray1. Similarly, a sheet “Paper2” is selected for a sheet feeding unit Tray2, and thus property information of “Paper2” is related to the sheet feeding unit Tray2, and a sheet “MediaEx” is selected for a sheet feeding unit Tray3, and thus property information of “MediaEx” is related to the sheet feeding unit Tray3. On the other hand, as for a sheet feeding unit Tray4, no sheet registered in the sheet information storage unit 401 is selected, and thus no sheet property information is related to the sheet feeding unit Tray4.

In a case where it is determined in S601 that the registration screen 801 is called, the processing flow proceeds to S602. On the other hand, in a case where the answer to S601 is NO, the processing flow remains in S601 until the registration screen 801 is called.

In S602, the CPU 207 displays the registration screen 801 on the operation unit 209 of the server 101. The processing flow then proceeds to S603.

In S603, the CPU 207 acquires information associated with a group name 802 input by a user on the operation unit 209 of the server 101. The processing flow then proceeds to S604. Note that the group name 802 may alternatively be imported from an external apparatus such as the information processing apparatus 104, the printing apparatus 102, or the like.

In the example illustrated in FIG. 8, sheets of groups respectively related to Tray1 to Tray3 are for use in producing booklets. To make it easy to recognize that these groups are for “booklet”, a user may input “booklet” as a group name 802 in a group name box. In S603, the group name 802 is acquired. In this specific example, “booklet” is acquired.

In S604, the CPU 207 determines whether one of sheets registered in the sheet information storage unit 401 allocated in the HDD unit 205 of the server 101 is selected for a sheet feeding unit.

In a case where it is determined that the selection is performed, the processing flow proceeds to S605. On the other hand, in a case where the answer to S604 is NO, the processing flow remains in S604 until a sheet is selected.

In S605, the CPU 207 retrieves the property information of the sheet selected in S604 from sheet information registered in the sheet information storage unit 401 allocated in the HDD unit 205 of the server 101.

In S606, the CPU 207 acquires the property information of the present sheet from the sheet information retrieved in S605. The sheet property information acquired in S606 may include, for example, information indicating a size, a basis weight, a color, a sheet type, and/or the like, of the sheet. Note that sheet information about the name, the size, the basis weight, the color, and the sheet type, and/or the like may alternatively be imported from an external apparatus such as the information processing apparatus 104, the printing apparatus 102, or the like.

The processing flow then proceeds to S607 in which the CPU 207 relates the property information of the sheet acquired in S606 to the sheet feeding unit. The processing flow then proceeds to S608.

In S608, the CPU 207 waits for a user to perform an operation on the registration screen 801 displayed on the operation unit 209 of the server 101.

When some operation performed by a user is accepted, the process proceeds to step S609. If no operation by a user is accepted, the processing flow remains in S608 until some operation is accepted.

In S609, the CPU 207 determines whether a finish button 803 is pressed on the registration screen 801 displayed on the operation unit 209 of the server 101.

In a case where it is determined that the finish button 803 is pressed, it is determined that the process of relating the property information of the sheet to the sheet feeding unit is completed, that is, the group setting process is completed, and thus the processing flow proceeds to S610. On the other hand, in a case where it is determined that the finish button 803 is not pressed, it is determined that the group setting process is not yet completed, and the processing flow returns to S604.

In S610, the CPU 207 determines whether the groups registered in the group setting storage unit 402 allocated in the HDD unit 205 of the server includes such a group for which sheet sizes related to sheet feeding units are all identical to those of the present group subjected to the setting described above.

In a case where a combination of a plurality of sheet feeding units and sizes of sheets related to the respective sheet feeding units is equal to that of another group, it is not possible to uniquely identify a group from sizes of sheets held in sheet feeding units. Also in a case where a combination of a plurality of sheet feeding units and sizes of sheets for a certain group is included in a combination for another group, it is not possible to uniquely identify a group from sizes of sheets held in sheet feeding units. Therefore, in the registration according to the present embodiment, it is not allowed to register a plurality of groups for which combinations of sizes of sheets related to sheet feeding unit are completely equal or a combination is included in a combination of another group.

For example, in a case where there is an already registered group (first group) having a combination of “Tray1: A3 thick paper, Tray2: B4 plain paper”, it is not allowed to further register a group (second group) defined to have a combination of, for example, “Tray1: A3 plain paper, Tray2: B4 thick paper, Tray3: A4 plain paper” because of the following reason.

In these two groups, the sheet size related to Tray1 is equally A3, and the sheet size related to Tray2 is equally B4. On the other hand, Tray3 is not related to any sheet in the group (first group) having the combination of “Tray1: A3 thick paper, Tray2: B4 plain paper”, but the combination associated with the second group includes the combination associated with the first group. Therefore, the first group having the combination of “Tray1: A3 thick paper, Tray2: B4 plain paper” and the second group having the combination of “Tray1: A3 plain paper, Tray2: B4 thick paper, Tray3: A4 plain paper” are determined that the combinations of sheet sizes related to the sheet feeding units are equal.

In a case where it is determined in S610 that a group equal, in terms of the combination, to the present group of interest is already registered, the processing flow proceeds to S611.

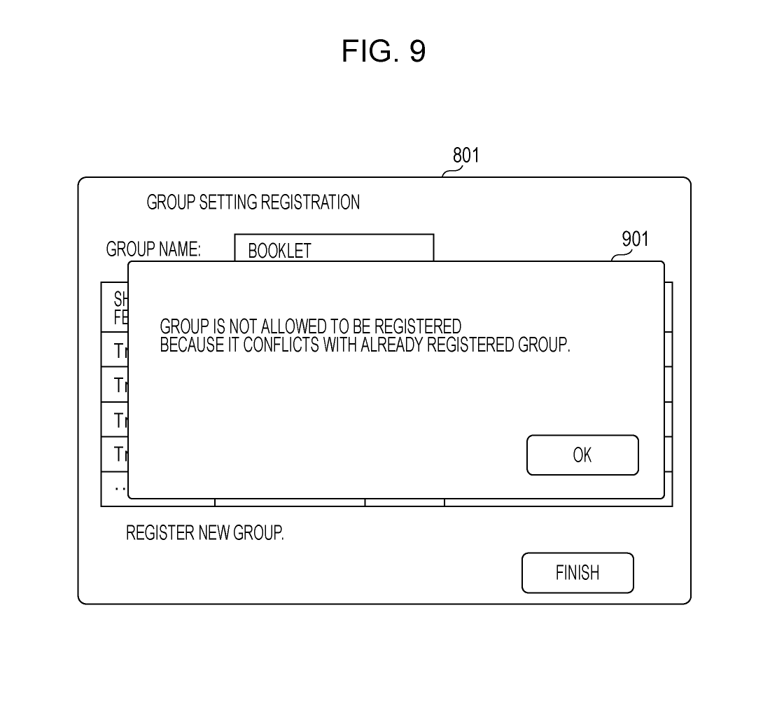

In S611, the CPU 207 displays a warning screen 901 (FIG. 9) on the operation unit 209 of the server 101 to notify that the group being tried to be newly registered after being subjected to the setting described above is not allowed to be registered in the group setting storage unit 402 allocated in the HDD unit 205 of the server 101.

On the other hand, in a case where it is determined in S610 that no such group is registered, the processing flow proceeds to S612.

In S612, the CPU 207 registers the group, for which the setting is completed, in the group setting storage unit 402 allocated in the HDD unit 205 of the server 101.

After S611 or S612, the process of registering the group in the group setting storage unit 402 is ended.

The process of registering the group in the group setting storage unit 402 has been described above in detail. In the case where the process is performed on the printing apparatus 102, the process may be performed in a similar manner to a case where the process is performed on the server 101 if the units used in the process are read as follows. That is, the CPU 207, the operation unit 209, and the HDD unit 205 used in the process on the server 101 respectively may be read as the CPU 302, the operation unit 318, and the HDD 308 in the process on the printing apparatus 102.

A further description of the first embodiment is given below for a case where property information is registered all at once for a plurality of sheets such that the property information of each sheet is related to corresponding one of sheet feeding units based on sizes of sheets held in the respective sheet feeding units. That is, when a sheet feeding unit is closed, the size of a sheet held in the closed sheet feeding unit is detected, and, based on the detected size, a group is searched for from the group setting storage unit 402. The property information of sheet of the group detected in the search is registered so as to be related to the closed sheet feeding unit.

In the following description of the operation according to the first embodiment, groups illustrated in FIG. 10 have already been registered in the group setting storage unit 402.

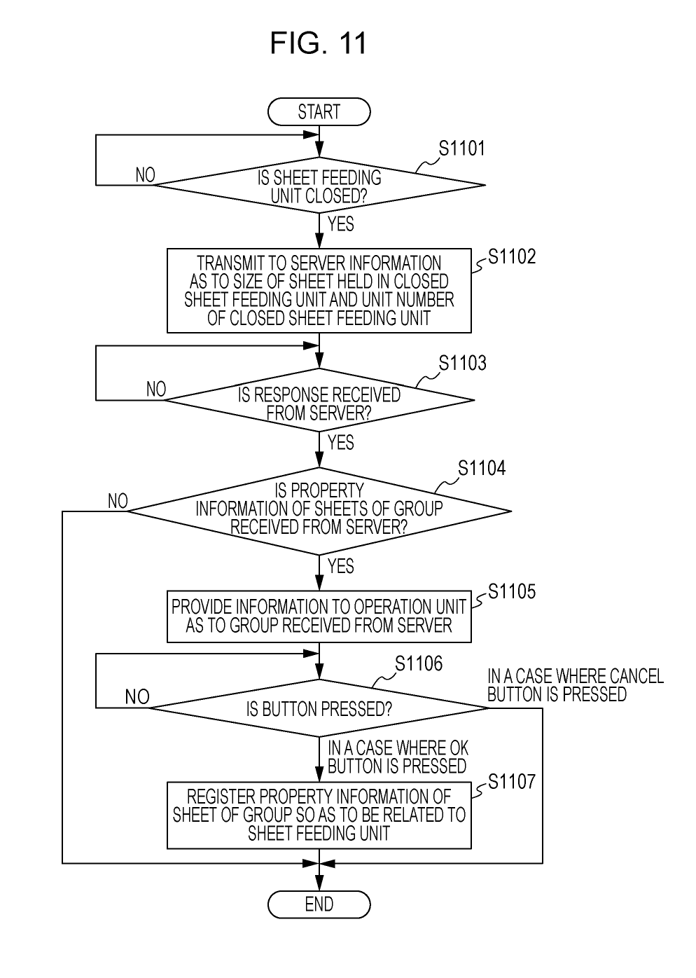

Referring to a flow chart illustrated in FIG. 11, a description is given below as to a sequence of processing steps of registering property information of sheets all at once for a group such that the sheet property information is related to a corresponding one of sheet feeding units. This process is performed on the printing apparatus 102 such that the CPU 302 executes a program loaded from the HDD 308 into the RAM 303 to achieve the process.

First, in S1101, the CPU 302 determines whether a sheet feeding unit in an open state is closed. Note that a user is assumed to open a sheet feeding unit to put sheets to be used in a job into the sheet feeding unit. After the user puts the sheets, the user closes the sheet feeding unit in the open state. In a case where it is determined that a sheet feeding unit is closed, the processing flow proceeds to S1102. On the other hand, in a case where the answer to S1101 is NO, the processing flow remains in S1101. Note that closing of a sheet feeding unit from an open state may be detected based on information acquired from the open/close detection sensor 326 illustrated in FIG. 3 or the like.

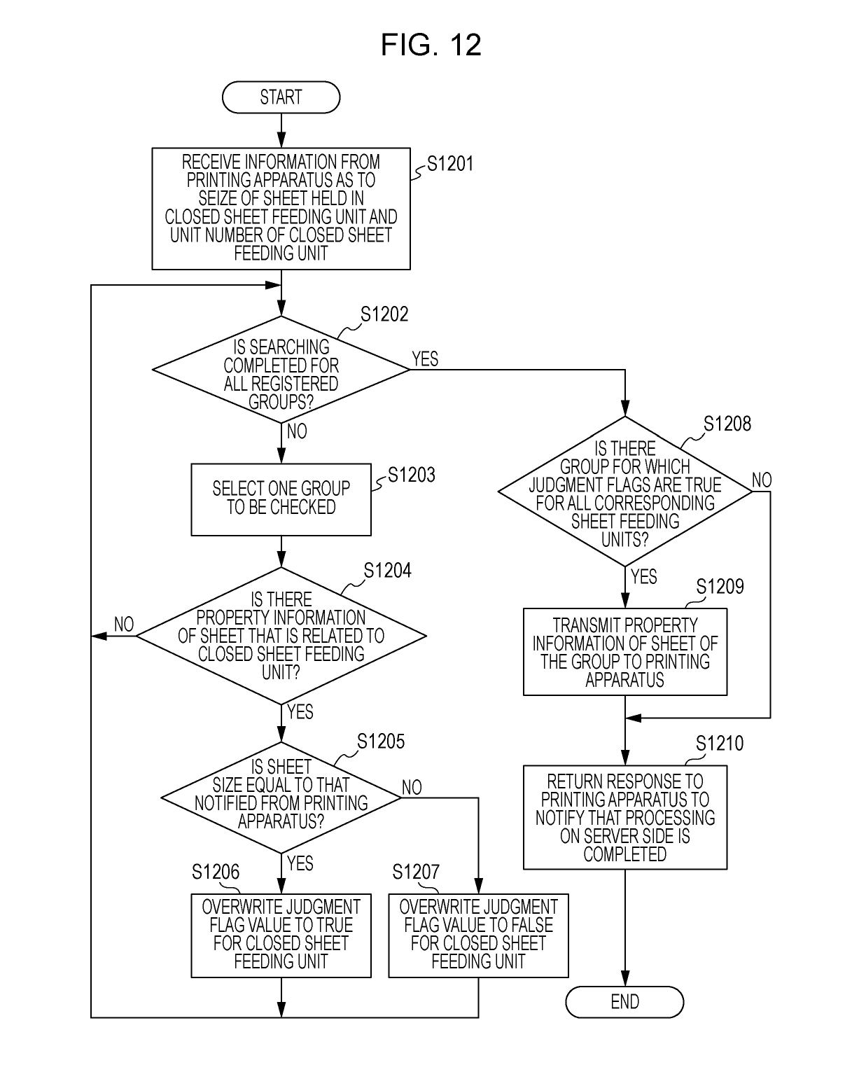

In S1102, the CPU 302 acquires the size of the sheet held in the sheet feeding unit determined to be closed in S1101, and transmits information indicating the acquired sheet size together with information indicating the unit number (for example, Tray1) of the closed sheet feeding unit to the server 101 via the network 105. Note that the sheet size of a sheet held in each sheet feeding unit may be detected based on information acquired from the size detection sensor 325 illustrated in FIG. 3 or the like. The information transmitted in S1102 from the printing apparatus 102 is received by the server 101 in S1201 as described later with reference to FIG. 12.

The processing flow then proceeds to S1103 in which the CPU 302 determines whether a response from the server 101 is received via the network 105 after the transmission of the sheet size and the unit number of the closed sheet feeding unit to the server 101 in S1102.

In a case where it is determined that a response from the server 101 is received, the processing flow proceeds to S1104. On the other hand, in a case where the answer to S1103 is NO, the processing flow remains in S1103. In a case where no response from the server 101 is returned within a predetermined period, time out may occur. In this case, it may be allowed to exit the sequence of steps of setting property information of sheets to sheet feeding units belonging to a group illustrated in FIG. 11. Note that the information received in S1103 by the printing apparatus 102 is responded to by the server 101 in S1210 described below with reference to FIG. 12.

In S1104, the CPU 302 determines whether sheet property information of a group is received from the server 101. Note that the information received in S1104 by the printing apparatus 102 is transmitted the server 101 in S1209 described below with reference to FIG. 12.

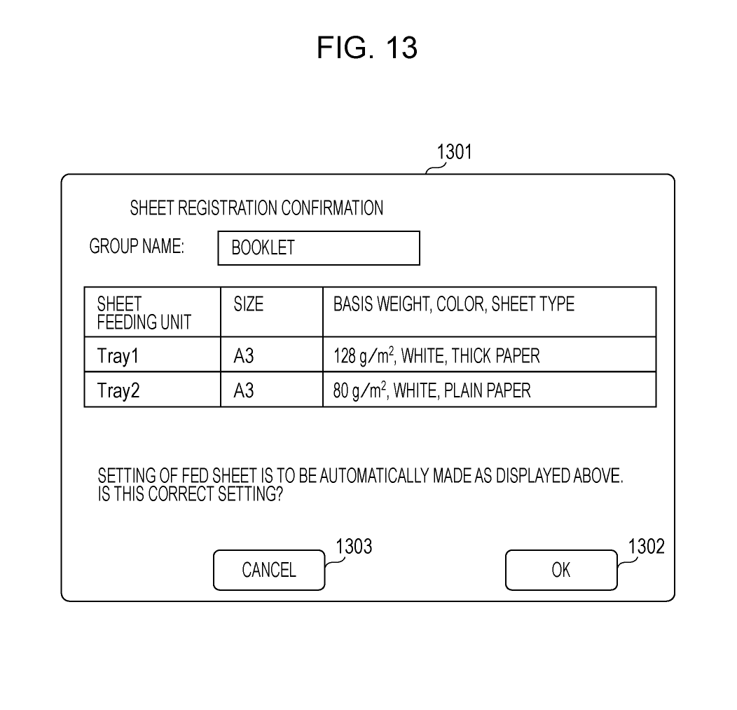

In a case where it is determined that sheet property information of a group is received from the server 101, the processing flow proceeds to S1105. In S1105, the CPU 302 displays a confirmation screen 1301 such as that illustrated in FIG. 13 on the operation unit 318 of the printing apparatus 102 to notify a user of the sheet information of the group received in S1104 from the server 101. Based on the information displayed on the confirmation screen 1301, the user is allowed to determine whether the property information of the sheet of the group received from the server 101 is to be registered for the sheet feeding unit.

The processing flow then proceeds to S1106, in which the CPU 302 waits for a user to perform an operation on the confirmation screen 1301. The processing flow remains in S1106 until an operation of pressing an OK button 1302 or a cancel button 1303 by a user is accepted. In a case where it is determined that the OK button 1302 on the confirmation screen 1301 is pressed, the processing flow proceeds to S1107. In S1107, the CPU 302 registers the sheet property information of the group received in S1104 such that it is related to the sheet feeding unit. After that, the process of registering sheet property information of the group so as to be related to the sheet feeding unit at a time for all is ended.

On the other hand, in a case where it is determined in S1106 that the cancel button 1303 on the confirmation screen 1301 is pressed, the process of registering sheet property information of the group all at once so as to be related to the sheet feeding unit is ended.

In a case where it is determined in S1104 that the sheet property information of the group is not received, the process of registering sheet property information of the group all at once so as to be related to the sheet feeding unit is ended.

The detailed description has been given above as to the sequence of processing steps of registering sheet property information of the group all at once so as to be related to the sheet feeding unit.

Next, a description is given below with reference to a flow chart illustrated in FIG. 12 as to a sequence of processing steps performed on the server 101 to search for a group registered in the group setting storage unit 402 according to the first embodiment. This process is performed on the server 101 such that the CPU 207 executes a program loaded from the HDD unit 205 into the second memory unit 208. Although in the first embodiment, the description is given by way of example for the case where the process of searching for a group registered in the group setting storage unit 402 is performed on the server 101, the process may alternatively be performed on the printing apparatus 102. In the case where the process is performed on the printing apparatus 102, the CPU 302 executes a program loaded from the HDD 308 into the RAM 303 to achieve the process. On the other hand, in a case where the information processing apparatus 104 plays a role as a server instead of the server 101, the process described above may be performed on the information processing apparatus 104.

First, in S1201, the CPU 207 receives information from the printing apparatus 102 via the network 105 as to the size of the sheet held in the closed sheet feeding unit and the unit number of the closed sheet feeding unit. Note that the information received in S1201 by the server 101 is transmitted by the printing apparatus 102 in S1102 in FIG. 11 described above.

The processing flow then proceeds to S1202 in which the CPU 207 determines whether the searching is completed for all groups registered in the group setting storage unit 402 allocated in the HDD unit 205 of the server 101.

In a case where it is determined that the searching is not completed for all registered groups, the processing flow proceeds to S1203.

In S1203, the CPU 207 selects one group to be next subjected to the searching from the groups stored in the group setting storage unit 402 allocated in the HDD unit 205 of the server 101. The processing flow then proceeds to S1204.

In S1204, the CPU 207 checks the group selected in S1203 as being to be next subjected to the searching to determine whether the selected group includes sheet property information related to the closed sheet feeding unit.

In the following description, it is assumed by way of example that the group selected in S1203 as the next group to be subjected to the searching is a booklet 1001 in the example illustrated in FIG. 10, and the closed sheet feeding unit is Tray3. In this specific case, it is determined in S1204 that no sheet property information is related to the closed sheet feeding unit (Tray3) in the group “booklet 1001”.

In a case where it is determined in S1204 that there is sheet property information related to the closed sheet feeding unit (Tray3) in the group “booklet 1001”, the processing flow proceeds to S1205. On the other hand in a case where it is determined that there is no sheet property information related to the closed sheet feeding unit (Tray3) in the group “booklet 1001”, the processing flow returns to S1202 and the process is performed again from S1202.

In S1205, the CPU 207 checks the group selected in S1203 as the next group to be subjected to the searching to determine whether the size of the sheet related to the closed sheet feeding unit is equal to the size of the sheet held in the closed sheet feeding unit indicated by the information received in S1201.

In a case where it is determined that the sheet sizes are equal, the processing flow proceeds to S1206. In S1206, for the group selected in S1203 and being subjected to the searching, the CPU 207 updates the value of a judgment flag corresponding to the closed sheet feeding unit such that it is overwritten to true. Thereafter, the processing flow returns to S1202. Note that the initial value of the judgment flag corresponding to any sheet feeding unit is false for any sheet in the group. The updated value of the judgment flag is stored in a nonvolatile manner in the HDD unit 205 of the server 101.

On the other hand, in a case where it is determined that the sheet sizes are not equal, the processing flow proceeds to S1207. In S1207, for the group selected in S1203 and being subjected to the searching, the CPU 207 updates the value of a judgment flag corresponding to the closed sheet feeding unit such that it is overwritten to false. Thereafter, the processing flow returns to S1202.

On the other hand, in a case where it is determined in S1202 that the searching is completed for all registered groups, the processing flow proceeds to S1208. In S1208, the CPU 207 determines whether there is a group in which the judgment flag is set to true for all sheet feeding units in the group.

In a case where it is determined that such a group exists, the processing flow proceeds to S1209. In S1209, the CPU 207 transmits information to the printing apparatus 102 via the network 105 as to the property information of all sheets of the group in which the value of the judgment flag is true for all sheet feeding units in the group. Thereafter the processing flow proceeds to S1210. Note that the sheet property information transmitted in S1209 to be registered for the sheet feeding unit may include information indicating the basis weight, the color, the sheet type, and/or the like in addition to the sheet size. Note that the information transmitted in S1209 by the server 101 is received by the printing apparatus 102 in S1104 in FIG. 11 described above.

On the other hand, in a case where the answer to S1208 is NO, that is in a case where there is no such group in which the judgment flag is set to true for all sheet feeding units in the group, the processing flow proceeds to S1210.

In S1210, the CPU 207 returns a response to the printing apparatus 102 via the network 105 to notify that the processing on the server 101 is completed. Note that the information returned in S1210 from the server 101 is received by the printing apparatus 102 in S1103 in FIG. 11 described above.

After the process in S1210 is completed, the process of searching for groups registered in the group setting storage unit 402 is ended.

The sequence of processing steps of searching for groups registered in the group setting storage unit 402 has been described above in detail. In the case where the process is performed on the printing apparatus 102, the process may be performed in a similar manner if the units used in the process are read as follows for all steps. That is, the CPU 207, the operation unit 209, and the HDD unit 205 used in the process on the server 101 respectively may be read as the CPU 302, the operation unit 318, and the HDD 308 in the process on the printing apparatus 102.

Furthermore, details of S1201, S1205, S1209, and S1210 are read as follows. In S1201, “information indicating the sheet size and the unit number of the closed sheet feeding unit is received from the printing apparatus 102 via the network 105” is read as “the information indicating the sheet size is acquired from the size detection sensor 325, and the information indicating the unit number of the closed sheet feeding unit is acquired from the open/close detection sensor 326”. In S1205, “the size of the sheet held in the closed sheet feeding unit indicated by the information received in S1201” is read as “the size of the sheet held in the closed sheet feeding unit indicated by the information received in S1201”. In S1209, “all sheet property information of the group is transmitted to the printing apparatus 102 via the network 105” is read as “sheet property information of the group is acquired”. In S1210, “a response is returned via the network 105 to notify that the process on the side of the server 101 is completed” is read as “nothing is performed”.

The above reading makes it possible for the printing apparatus 102 to perform the operation in a similar manner to the case where the operation is performed on the server 101.

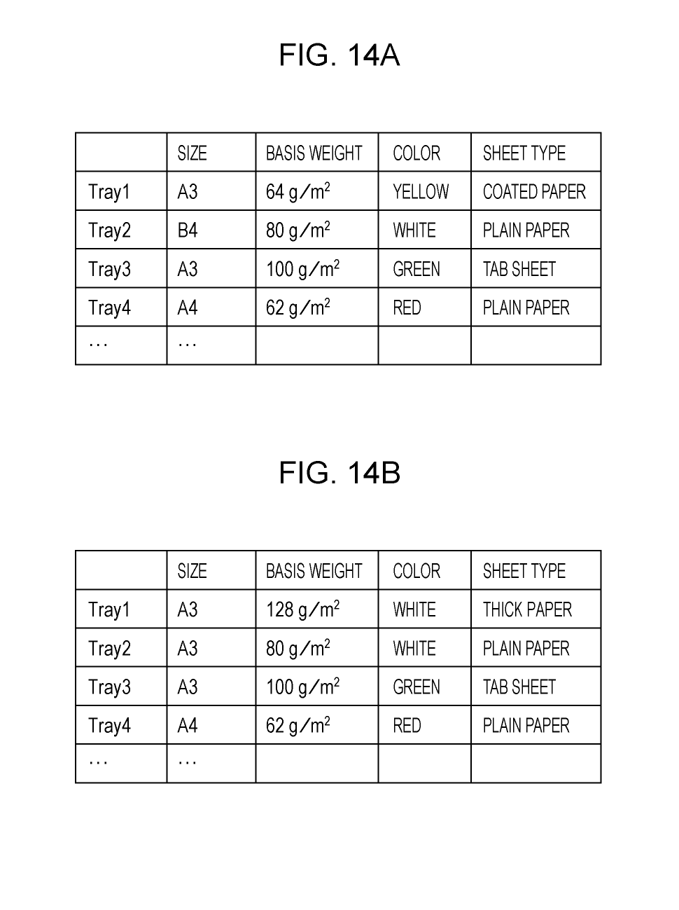

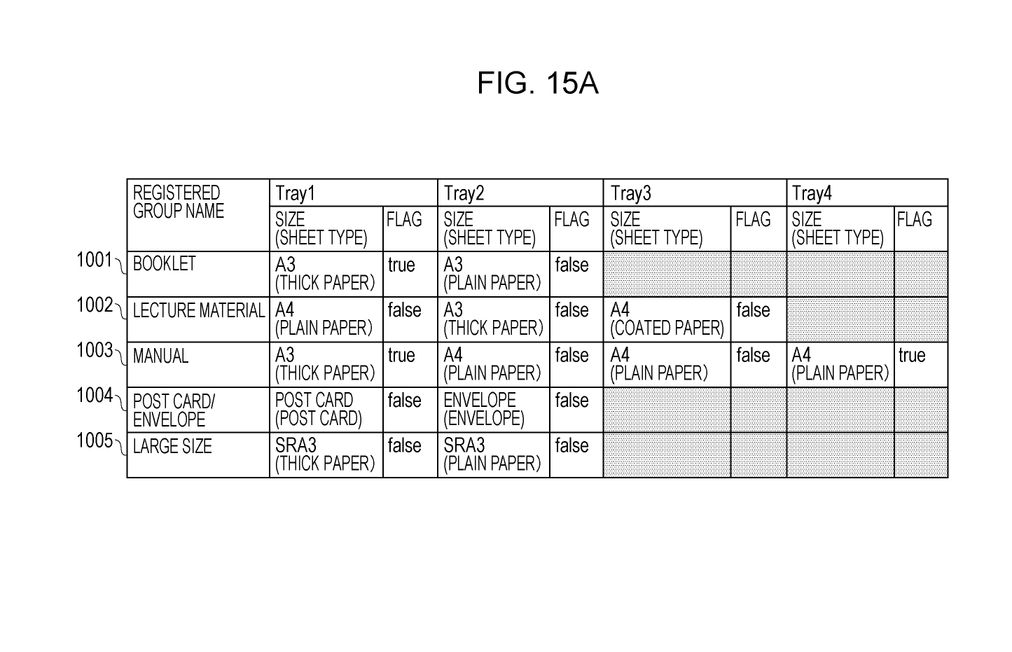

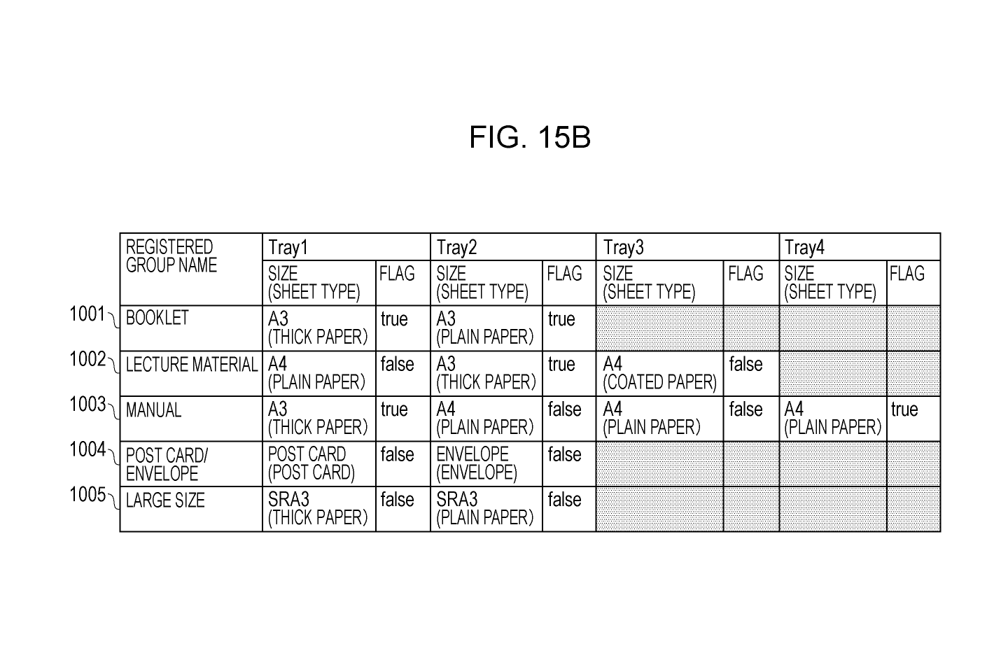

An example of a result of the searching for groups registered in the group setting storage unit 402 according to the first embodiment is described below with reference to FIGS. 14A and 14B and FIGS. 15A and 15B.

FIGS. 14A and 14B illustrates examples of property information of sheets related to respective sheet feeding units of the printing apparatus 102. Note that the groups illustrated in FIGS. 15A and 15B are the same as those illustrated in FIG. 10, and thus the same reference symbols are used.

In the example in FIG. 14A, registration is made such that A3 thick paper is related to Tray1, B4 plain paper is related to Tray2, A3 tab sheet is related to Tray3, and A4 plain paper is related to Tray4. Sheets held in the respective sheet feeding units have sizes indicated by the corresponding sheet property information. In this case, the judgment flags for the sheet feeding units in the respective groups are given as illustrated in FIG. 15A.

For example, let it be assumed that a user opens the sheet feeding unit Tray2 and replaces sheets of “B4 plain paper” held in the sheet feeding unit Tray2 with sheets of “A3 plain paper” to use in a job, and then the user closes the sheet feeding unit Tray2. In this case, searching is performed to find groups in which sheet size “A3” equal to that of new sheets put in the closed sheet feeding unit (Tray2) is related to Tray2.

As a result of the searching, in the example illustrated in FIG. 15A, “booklet” 1001 and “lecture material” 1002 are found as such groups. Thus, as illustrated in FIG. 15B, the values of the judgment flags of the groups “booklet” 1001 and “lecture material” 1002 are overwritten from “false” to “true”.

Thus, in the situation such as that in the example in FIG. 15B, a group in which all judgment flags for sheet feeding units are true is identified as “booklet” 1001.

Therefore, in S1209 in FIG. 12 described above, the sheet property information associated with the group “booklet” 1001 is transmitted to the printing apparatus 102. In S1105 in FIG. 11 described above, the confirmation screen 1301 illustrated in FIG. 13 is displayed on the operation unit 318 of the printing apparatus 102. Thus, if a user presses the OK button 1302 on the confirmation screen 1301, then the sheet property information of the group “booklet” 1001 is registered so as to be related to Tray1 and Tray2 as illustrated in FIG. 14B.

Upon the registration of the sheet property information for the group “booklet” 1001, the sheet property information for Tray1 is changed from “A3 coated paper” to “A3 thick paper”. However, sheets held in Tray 1 is not of “A3 thick paper” but still of “A3 coated paper”. Therefore, not “A3 thick paper” but “A3 coated paper” is fed from Tray1 when a job for the group “booklet” 1001 is executed, and it is necessary to prevent this situation from occurring. To handle such a situation, when the sheet property information associated with the group “booklet” 1001 is registered for Tray 1, a notification may further be given to prompt a user to replace sheets held in Tray1 with correct sheets.

In the first embodiment, as described above, when a sheet feeding unit is closed, groups are searched for from the group setting storage unit 402 based on the size of sheets held in the closed sheet feeding unit and the unit number of the closed sheet feeding unit. In a case where the result of the search indicates that there is a group in which the values of the judgment flags are true for all sheet feeding units in the group, it is allowed to register, all at once, sheet property information of sheets so as to be related to corresponding sheet feeding units belonging to the group. That is, in a case where a plurality of sheets are used in executing one job, property information of the sheets is correctly registered so as to be related to corresponding sheet feeding units all at once, which makes it unnecessary for a user to input every detail of property information for all sheets each time registration is performed.

In the first embodiment described above, it is assumed by way of example but not limitation that when a sheet feeding unit in an open state is closed, the information indicating the size of the sheet held in the closed sheet feeding unit and the information indicating the unit number of the closed sheet feeding unit are transmitted to the server 101, and the following process is performed based on the transmitted information. Alternatively, for example, a button may be provided on the operation unit 318 such that when the button is pressed, the information indicating the size of the sheet held in the sheet feeding unit is transmitted to the server 101, and the following process is performed based on the transmitted information.

It is also assumed by way of example that the information transmitted to the server 101 is as to the size of a sheet held in a sheet feeding unit. Alternatively, another item of sheet property information may be transmitted. For example, in a case where a sensor is provided on a sheet feeding unit to detect a color of a sheet, and sheet color information is registered in the sheet information storage unit 401 and the group setting storage unit 402, then the sheet color information may be transmitted together with the sheet size information to the server 101, and a sheet may be selected based on the color and the size. Alternatively, only sheet color information instead of the sheet size information may be transmitted to the server 101, and a sheet may be selected based only on the sheet color.

### Second Embodiment

In the first embodiment described above, in a case where the result of the searching for groups from the group setting storage unit 402 indicates that there is no group in which the values of the judgment flags for corresponding sheet feeding units are all true, a response is returned to the printing apparatus 102 to notify that the process on the server 101 is completed.

In contrast, in a second embodiment described below, in a case where the result of the searching for groups indicates that there is no group in which the values of the judgment flags are true for all corresponding sheet feeding units belonging to the group, sheet property information of a particular group registered in the group setting storage unit 402 is transmitted to the printing apparatus 102. Thereafter, a response is transmitted to the printing apparatus 102 to notify that the processing on the server 101 is completed.

In the second embodiment, a sequence of processing steps of registering sheet information in the sheet information storage unit 401 allocated in the HDD unit 205 of the server 101 (or in the HDD unit 308 of the printing apparatus 102) is similar to that illustrated in the flow chart in FIG. 5, and thus a further detailed description thereof is omitted. A sequence of processing steps of registering a group in the group setting storage unit 402 allocated in the HDD unit 205 of the server 101 (or in the HDD unit 308 of the printing apparatus 102) is similar to that illustrated in the flow chart in FIG. 6, and thus a further detailed description thereof is omitted.

In the printing apparatus 102 according to the second embodiment, a sequence of processing steps of registering, all at once, sheet property information so as to be related to corresponding one of sheet feeding units belong to a group includes similar steps to those according to the first embodiment described above with reference to the flow chart illustrated in FIG. 11, and thus a further detailed description of such similar steps (S1101 to S1104 and 1107) is omitted.

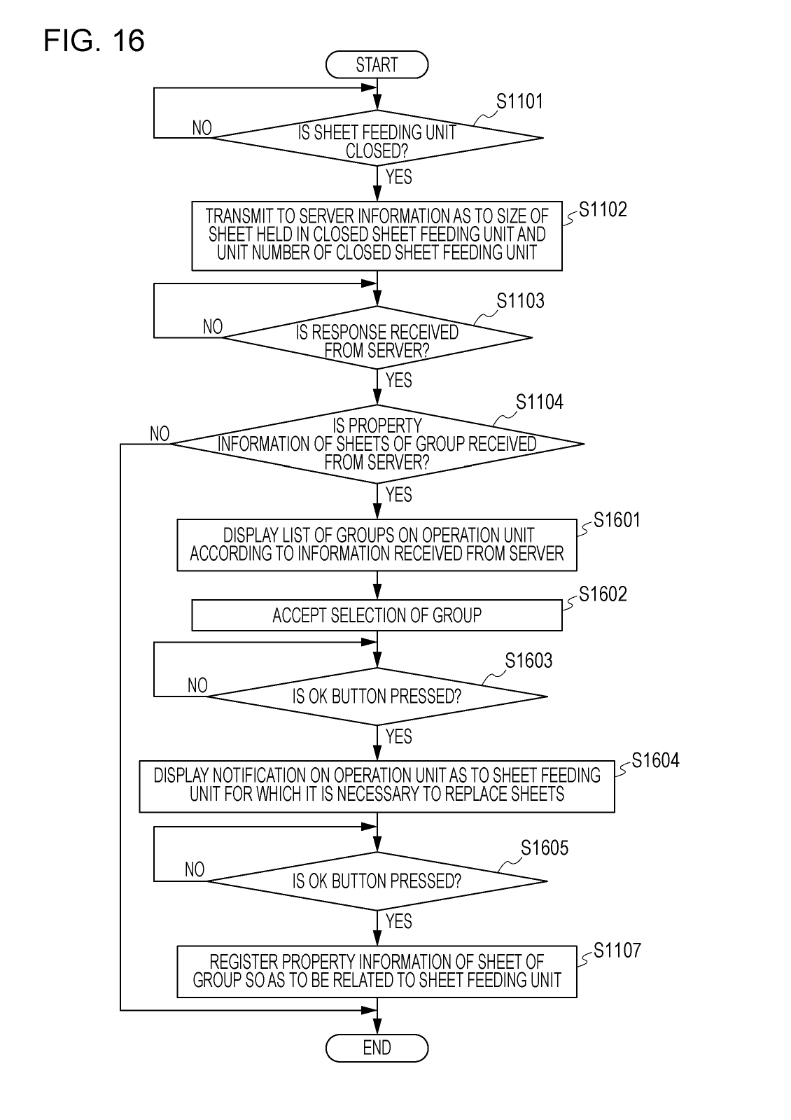

However, in the second embodiment, in a case where the answer to S1104 in FIG. 11 is YES, the following steps (S1601 to S1605) are performed differently from the first embodiment, and thus, focus is placed on a difference from the first embodiment in the following description of the second embodiment with reference to a flow chart illustrated in FIG. 16.

In S1104, the CPU 302 determines whether sheet property information of a group is received from the server 101. In a case where it is determined that sheet property information of a group is received from the server 101, the processing flow proceeds to S1601.

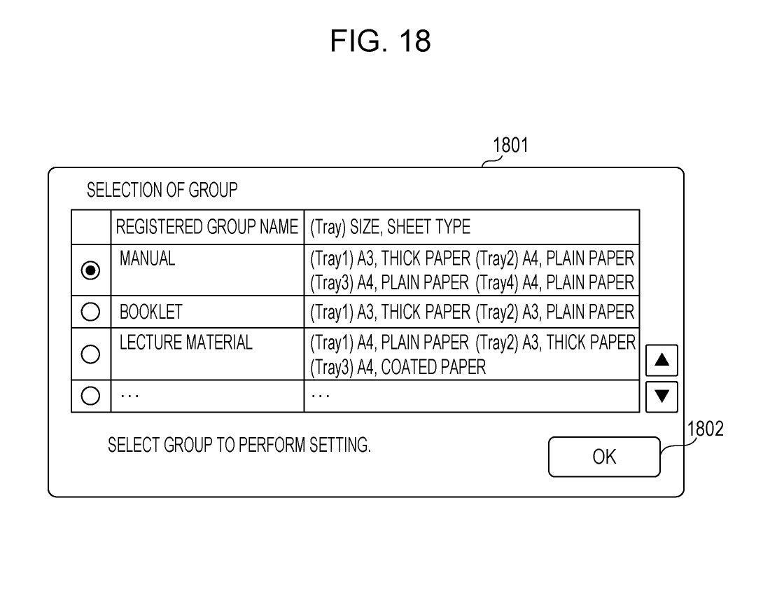

In S1601, the CPU 302 displays, on the operation unit 318 of the printing apparatus 102, a list of groups received from the server 101 via the network 105. More specifically, a selection screen 1801 such as that illustrated in FIG. 18 is displayed such that particular candidates for groups registered in the group setting storage unit 502 are listed. A user is allowed to select one of groups on the selection screen 1801. Note that the information received in S1601 by the printing apparatus 102 is transmitted in S1701 in FIG. 7 described below from the server 101. Information as to a history of use of groups registered all at once so as to be related to corresponding sheet feeding units in the above-described manner may be stored in the HDD 308 such that the CPU 302 is allowed to refer to the use history information and display the list of groups on the operation unit 318 based on the use history information such that the groups are sorted according to the date/time when the groups are used or according to the frequency of use.

Thereafter, the processing flow proceeds to S1602, in which the CPU 302 accepts a selection of a group performed by a user on the selection screen 1801. After one group is accepted, the processing flow proceeds to S1603, in which a determination is performed as to whether the OK button 1802 on the registration screen 801 is pressed by a user. If the OK button 1802 is pressed, the processing flow proceeds to S1604. In a case where it is determined in S1603 that the OK button 1802 is not pressed, the processing flow remains in S1603 until the OK button 1802 is pressed.

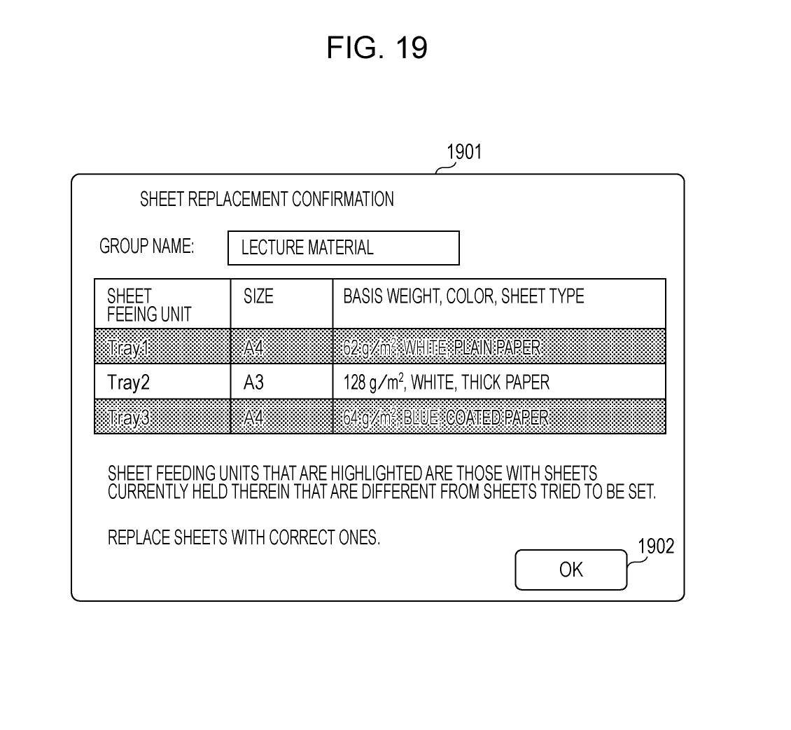

In S1604, because it is necessary to replace sheets, the CPU 302 displays information on the operation unit 318 of the printing apparatus 102 to indicate a sheet feeding unit for which it is necessary to replace sheets. More specifically, the confirmation screen 1901 is displayed as illustrated in FIG. 19 so as to notify a user of a sheet feeding unit for which the current sheet property information is different from the sheet property information input in S1602 for the particular group thereby prompting the user to replace sheets.

Thereafter, the processing flow proceeds to S1605 in which the CPU 302 determines whether the OK button 1812 on the confirmation screen 1901 is pressed. In a case where it is determined that the OK button 1902 is pressed, the processing flow proceeds to S1107 in FIG. 11 to continue the following process. On the other hand, in a case where it is determined that the OK button 1812 is not pressed, the processing flow remains in S1605.

The detailed description has been given above as to the process of registering, all at once, sheet property information so as to be related to corresponding sheet feeding units in a group according to the second embodiment while placing the focus on the difference from the first embodiment.

Next, a description is given below as to a sequence of processing steps of searching for groups registered in the group setting storage unit 402 in the server 101 according to the second embodiment. The sequence of processing steps includes similar steps to those according to the first embodiment described above with reference to FIG. 12, and a further detailed description of the similar steps is omitted.

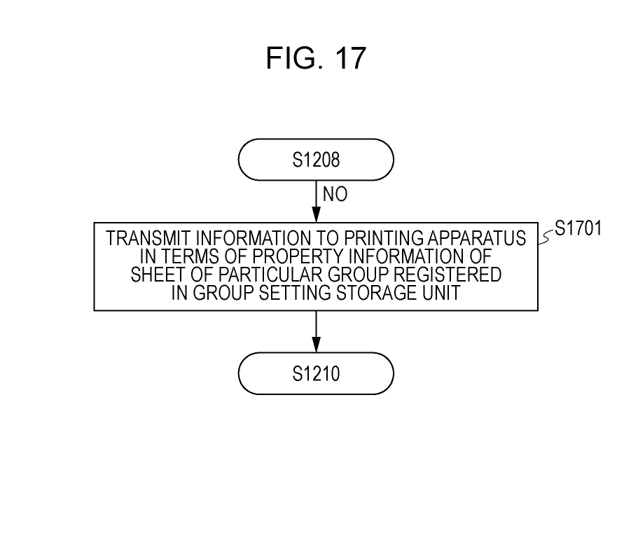

In the second embodiment, in the case where the answer to S1208 in FIG. 12 is NO, the following processing steps are performed differently from the first embodiment. Referring to a flow chart illustrated in FIG. 17, the sequence of processing steps according to the second embodiment is described below with a focus on the difference from the first embodiment.

In S1208 in FIG. 12, the CPU 207 determines whether there is a group in which the judgment flag has a value of true for all sheet feeding units in the group. In a case where it is determined that there is no such group, the processing flow proceeds to S1701. Note that in a case where the process is performed on the printing apparatus 102, the CPU 302 determines whether there is a group in which the judgment flag has a value of true for all sheet feeding units in the group, and in a case where it is determined that there is no such group, the processing flow proceeds to S1701.

In S1701, the CPU 207 transmits, to the printing apparatus 102 via the network 105, sheet property information of a particular one of the groups registered in the group setting storage unit 402 allocated in the HDD unit 205 of the server 101. Note that the information transmitted in S1701 by the server 101 is received by the printing apparatus 102 in S1601 in FIG. 16 described above. An alternative process in S1701 is to detect a group in which judgment flags have a value of true for many sheet feeding units, and preferentially transmit information indicating the detected group from the server 101 to the printing apparatus 102. A still alternative process is to detect a group in which judgment flags have a value of false for a small number of sheet feeding units, and preferentially transmit information indicating the detected group from the server 101 to the printing apparatus 102. Alternatively, sheet property information of all groups registered in the group setting storage unit 402 may be transmitted to the printing apparatus 102 from the server 101. Note that in the case where the process is performed on the printing apparatus 102, the CPU 302 acquires sheet property information of a particular group of the groups registered in the group setting storage unit 402 allocated in the HDD 308 of the printing apparatus 102.

In the example illustrated in FIG. 15A, there is no group in which the values of judgment flags are true for all corresponding sheet feeding units. On the other hand, “manual” 1003 is a group in which the values of judgment flags are true for the greatest number of sheet feeding units, and “booklet” 1001 is a group in which the values of judgment flags are true for the second greatest number of sheet feeding units. When groups in which the values of judgment flags are true for many sheet feeding units are detected in the above-described manner, these groups may be selected as high-priority candidates.

After the process in S1701 is completed, the processing flow proceeds to S1210 in FIG. 12 to continue the following process.

The detailed description has been given above as to the process of searching for groups registered in the group setting storage unit 402 according to the second embodiment while placing the focus on the difference from the first embodiment.

In the second embodiment, as described above, when there is no group in which the values of the judgment flags are true for all corresponding sheet feeding units, sheet property information of a group selected from particular groups may be registered, all at once, so as to be related to corresponding sheet feeding units. That is, in a case where a plurality of sheets are used in executing one job, property information of the sheets is correctly registered, all at once, so as to be related to corresponding sheet feeding units, which makes it unnecessary for a user to input every detail of property information for all sheets each time registration is performed.

Note that the present invention is not limited to the embodiments described above. Various modifications (including a combination of embodiments) are possible without departing from the scope of the invention.

In the embodiments described above, by way of example, a size is detected as one of items of sheet property information of the sheet feeding unit 322. However, alternatively, a plurality of items of sheet property information may be detected and transmitted, and the following process may be performed based on these items of the sheet property information.

In the embodiments described above, by way of example, the information transmitted to the server 101 is as to the size of a sheet held on the sheet feeding unit 322. In a case where sensors are provided on the sheet feeding unit 322 to detect a color of a sheet, a basis weight of the sheet, the sheet type of the sheet, and/or the like, and furthermore the color, the basis weight, the sheet type and/or the like of the sheet are registered in the sheet information storage unit 401 and the group setting storage unit 402, then information about the color, the basis weight, the type and/or the like of the sheet may be transmitted together with the size information to the server 101, and a sheet may be selected based on the sheet size, the sheet color, the basis weight of the sheet, the sheet type of the sheet, and/or the like. Alternatively, only sheet color information instead of the sheet size information may be transmitted to the server 101, and a sheet may be selected based only on the sheet color.

That is, in a case where acquired property information of the sheet feeing unit 322 includes at least one of the size, the basis weight, the color, and the sheet type of the sheet, it is allowed to set the sheet property information related to the sheet feeding unit such that the sheet property information includes additionally at least one item other than the acquired property information.

In the embodiments described above, by way of example, the printing apparatus 102 and the external server 101 are connected to each other via the network 105. Alternatively, the printing apparatus 102 and a printing control apparatus disposed in the printing apparatus 102 and functioning as a server may perform part or all of the control processes described above. Alternatively, part or all of the control processes described above may be performed only by the printing apparatus 102 without performing the process by the server 101 functioning as a printing control apparatus. That is, the server 101 functioning as the printing control apparatus may be disposed in the printing apparatus 102 or the information processing apparatus 104. Alternatively, the printing apparatus 102 may be connected to a plurality of information processing apparatuses 104 via the network 103 such as a LAN, a WAN, or a wireless LAN thereby making it possible to perform part or all of the control processes described above.

While the present invention has been described with reference to various embodiments and examples, the scope of the invention is not limited to particular descriptions given above.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-181187, filed Sep. 2, 2013, which is hereby incorporated by reference herein in its entirety.

What is claimed is:

1. A sheet management apparatus comprising:
a storing unit configured to store a combination of a size and first property information of a first sheet and a size and second property information of a second sheet;
an obtaining unit configured to obtain a first size of a sheet held in a first sheet holding unit and a second size of a sheet held in a second sheet holding unit; and
a setting unit configured to set sheet property information such that the first property information is read out from the combination including the first size and the second size obtained by the obtaining unit and the read first property information is set as sheet property information of a sheet held in the first sheet holding unit, and the second property information is read out from the combination and the read second property information is set as sheet property information of a sheet held in the second sheet holding unit.

2. The sheet management apparatus according to claim 1, further comprising
a display unit configured to display, as a candidate, the combination including the first size and the second size obtained by the obtaining unit; and
a selecting unit configured to select an arbitrary combination from the candidate for the combination displayed by the display unit,
wherein the setting unit reads out the first property information from the combination selected by the selecting unit and sets the read first property information as property information of the sheet held in the first sheet holding unit, and furthermore reads out the second property information from the combination and sets the read second property information as property information of the sheet held in the second sheet holding unit.

3. The sheet management apparatus according to claim 1, further comprising
a first detecting unit configured to detect closing of the first sheet holding unit, and
a second detecting unit configured to detect closing of the second sheet holding unit,
wherein upon detecting closing of the first sheet holding unit by the first detecting unit, the obtaining unit obtains the first size, and upon detecting closing of the second sheet holding unit by the second detecting unit, the obtaining unit obtains the second size.

4. The sheet management apparatus according to claim 1, wherein
the first property information includes at least one of a basis weight of a sheet, a color of the sheet, and a type of the sheet.

5. The sheet management apparatus according to claim 1, wherein
the second property information includes at least one of a basis weight of a sheet, a color of the sheet, and a type of the sheet.

6. A sheet management apparatus comprising:
a storing unit configured to store a combination of a size and first property information of a first sheet to be set so as to be related to a first sheet holding unit, and a size and second property information of a second sheet to be set so as to related to a second sheet holding unit;
an obtaining unit configured to obtain a first size of a sheet held in the first sheet holding unit and a second size of a sheet held in the second sheet holding unit; and
a setting unit configured to set sheet property information such that the first property information is read out from the combination in which the first size and the second size obtained by the obtaining unit are respectively related to the first sheet holding unit and the second sheet holding unit, and the read first property information is set as property information of the sheet held in the first sheet holding unit, and furthermore, the second property information is read from the combination and the read second property information set as property information of the sheet held in the second sheet holding unit.

7. A control method in a sheet management apparatus having a storing unit configured to store a combination of a size and first property information of a first sheet and a size and second property information of a second sheet, the control method comprising:
obtaining a first size of a sheet held in a first sheet holding unit and a second size of a sheet held in a second sheet holding unit; and
setting sheet property information such that the first property information is read out from the combination including the first size and the second size obtained and the read first property information is set as sheet property information of a sheet held in the first sheet holding unit, and the second property information is read out from the combination and the read second property information is set as sheet property information of a sheet held in the second sheet holding unit.

8. A computer readable storage medium storing a computer program to cause a sheet management apparatus to perform a method, wherein the a sheet management apparatus includes a storing unit configured to store a combination of a size and first property information of a first sheet and a size and second property information of a second sheet, the method comprising:
obtaining a first size of a sheet held in a first sheet holding unit and a second size of a sheet held in a second sheet holding unit; and
setting sheet property information such that the first property information is read out from the combination including the first size and the second size obtained and the read first property information is set as sheet property information of a sheet held in the first sheet holding unit, and the second property information is read out from the combination and the read second property information is set as sheet property information of a sheet held in the second sheet holding unit.
